(19) United States
(12) Patent Application Publication
(10) Pub. No.: US 2009/0172749 A1
(43) Pub. Date: Jul. 2, 2009

(54) REMODULATING SATELLITE TV CHANNELS FOR HOME DISTRIBUTION

(75) Inventor: Henry Gregg Martch, Parker, CO (US)

Correspondence Address: SETTER ROCHE LLP, PO BOX 780, ERIE, CO, 80516, US

(73) Assignee: EchoStar Technologies Corporation, Englewood, CO (US)

(21) Appl. No.: 11/966,209

(22) Filed: Dec. 28, 2007

(51) Int. Cl. H04N 7/18

(52) U.S. Cl. 725/78

(57) ABSTRACT

A remodulating interface is designed to receive control data such as frequency information from a power line data interface, and to use this information to control a remodulator that frequency shifts an input TV video signal from a first frequency (or television channel) to a second frequency (or television channel) for display on a television.

### BACKGROUND OF THE INVENTION

Currently millions of households receive some form of satellite television (TV) such as Dish Network™. Satellite TV typically requires subscribers to purchase or lease one or more small parabolic dishes, and a set top box (STB) coupled between the dish and the subscriber's television set. In a typical system, the dish commonly includes a LNB (Low Noise Block Down Converter) which converts the approximately 12-GHz signal from the satellite to the 1-GHz band as an intermediate frequency before sending the signal to the customer's STB. FIG. 1 illustrates the frequency spectrum for standard and cable-ready televisions. Standard televisions are equipped to receive signals on several bands including the VHF (Very High Frequency) Low band 100 between 90 and 108 MHz, the VHF High band 104 between 170 and 222 MHz, and the UHF (Ultra High Frequency) band 108 between 470 and 770 MHz. Additionally, some televisions are cable ready, and may include the cable mid band 102 between 108 and 170 MHz and the cable super high band 106 between 222 and 470 MHz.

The STB is often configured to receive the intermediate frequencies from the LNB and includes a channel selector which converts a channel from one of the intermediate frequencies into a channel which may be displayed by a typical television. A controller is also included in the STB which controls the conversion of the channel from an intermediate frequency to a standard TV channel. Most STBs also include a remote control device which is operated by a user to control the STB. Common wireless remote control devices use infrared (IR) or UHF signals to send user selections and control commands to the STB. Early STBs had a single tuner. This limited the early STBs to providing one output of a single TV channel to the customer's television set. Also, as more and more users added multiple televisions to their houses, when multiple users desired to watch different satellite channels on two or more televisions at the same time, additional STBs were required for the additional television sets.

STBs such as the Dish322™ from Dish Network™ include two tuners. FIG. 2 illustrates an example television system including a dual tuner STB. Alternately, the output receiving signal from one tuner may be connected to the input of a first television 202, and the output receiving signal from the second tuner may be connected to the input of a second television 204. Commonly, these two televisions will be in different rooms and the second output 208 will be carried on coaxial cable typically built into homes through one or more walls 210. Typically, the first output is set to either VHF channel 3 or 4. This is standard for many video output devices such as VCRs and DVD players and is a common TV input. The first output 206 of the STB 200 may be set to either channel 3 or 4 and the first television 202 is set to the same channel. Two channels are provided since it is likely that one of the channels will be used by a local broadcast channel, and there is some possibility of interference between the broadcast channel and the output of the STB 200. Typically, the second output is set to a UHF channel out of a wide range of available channels. As one example, the Dish322™ STB allows the customer to select one of a number of the UHF channels for the second output 208. This allows the output to have a wide range of available channels to avoid collision with over-the-air channels, cable channels, and other channels used by receivers in the in-home cable system. The second television 204 is tuned to the customer-selected UHF channel to receive the second output 208 from the STB 200. In this example, the STB 200 sends satellite video from the second output to the second television 204 over in-home coaxial cable 208 on a customer-selected UHF channel. This UHF channel may be selected from channels 21-69 of the off-air channels or from channels 73-125 of the cable channels. The customer is required to select a vacant channel for the STB to use. In one example, the user guide instructions for the Dish322™ requires the customer to perform 26 steps to select a UHF channel and set the second output channel of the STB. The customer must be familiar with how to change channels on their second television, and how to switch between off-air and cable channels, since it will be necessary for the customer to tune to other channels (than the standard 3 or 4) to view the satellite video from the STB.

Commonly, televisions automatically reset to channels 3 or 4, or to their RCA or S-video inputs after a power failure, and thus the customer may not need to change channels in order to receive satellite video from the STB on the first television after a reset. However, when a second television resets to channel 3 or 4, the customer is required to change the channel of the second television to whichever UHF channel was customer-selected previously in order to receive satellite video from the STB. This requires the customer to remember which UHF channel the STB sends out to the input of the second television, and also whether the input arrives through a cable or over-the-air (OTA) input.

If a VCR is used with the second television, typically the VCR input is connected to the coaxial cable conducting the second output from the STB, and the VCR output is connected to the second television. Commonly, VCRs output video on either channel 3 or 4, and the VCR must now be configured to receive the second output on the UHF channel selected by the customer. The VCR remodulates the UHF signal from the STB to channel 3 or 4 while the VCR is powered on. However, when the VCR is turned off, it typically transmits the UHF signal from its input directly to its output (and the TV) without remodulation, and the user must tune the TV from channel 3 or 4 to the previously selected UHF channel in order to receive satellite video. Then, when the VCR is turned on again, the user must tune the TV back to channel 3 or 4 in order to view the output of the VCR.

### BRIEF DESCRIPTION OF THE DRAWINGS

FIG. 1 illustrates the frequency spectrum for standard and cable-ready televisions.

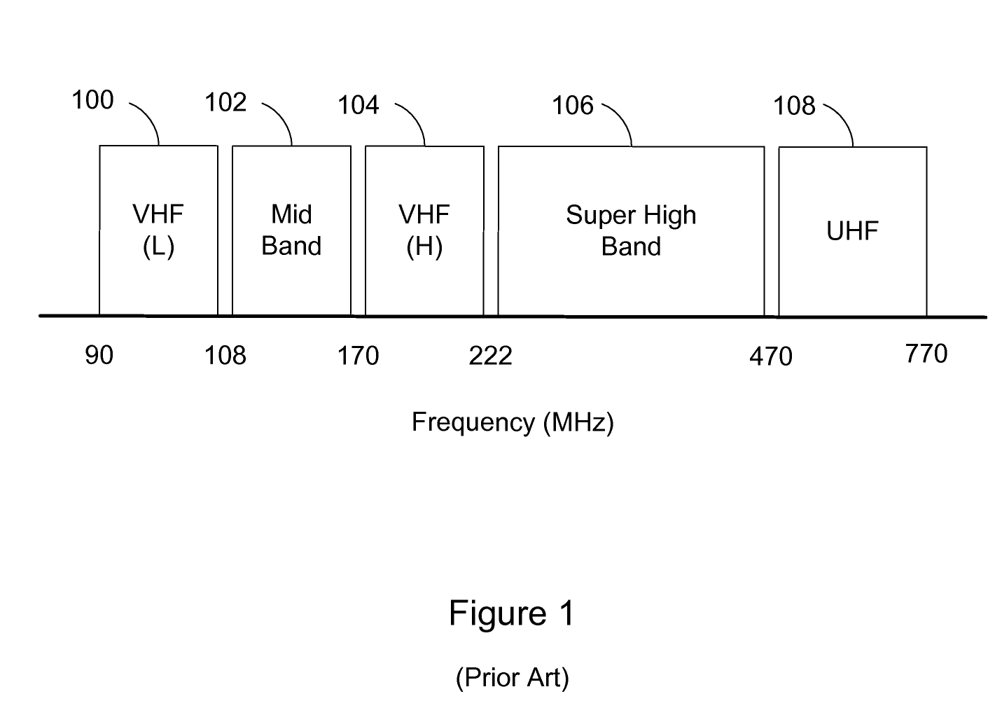

FIG. 2 illustrates an example television system including a dual tuner STB.

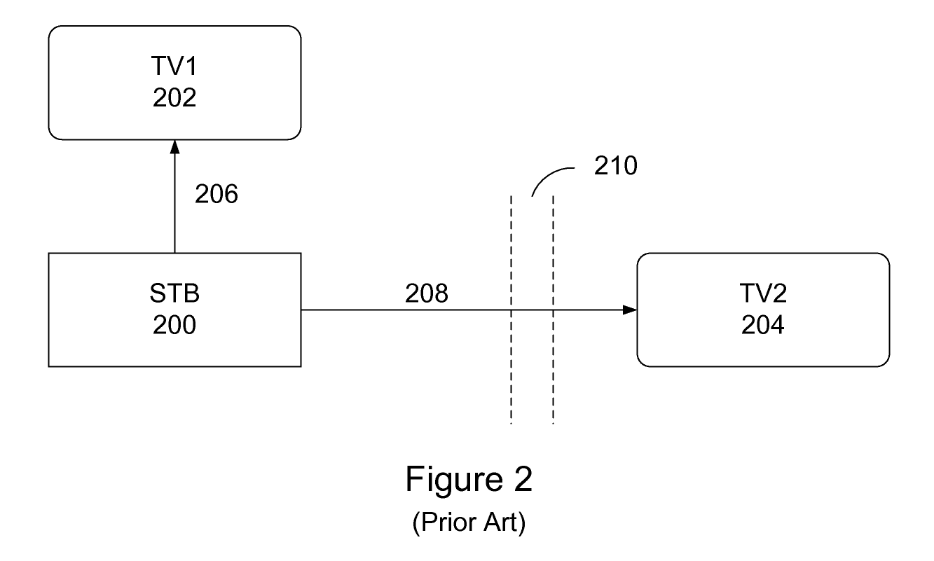

FIG. 3 illustrates an example two television system including a dual tuner STB, and a remodulating interface including a power line data interface according to an exemplary embodiment of the present invention.

FIG. 4 illustrates an example remodulating interface according to an exemplary embodiment of the present invention.

FIG. 5 illustrates an example application of a remodulating interface according to an embodiment of the present invention.

FIG. 6 illustrates a method for remodulating a TV signal according to an exemplary embodiment of the present invention.

### DETAILED DESCRIPTION OF THE PREFERRED EMBODIMENT

The HomePlug® Powerline Alliance has produced a standard useful for transmitting data through the electrical lines within a home or business. Similar other methods exist for transmitting data through electrical lines and may be used in the present invention. An example embodiment of the present invention uses HomePlug® technology; however, any other method for data transmission may be used. For example, other systems may use radio frequency (RF), bi-directional signaling through the coaxial (coax) cable, or other available data transmission methods. Using power line data transfer, a remodulating interface may be constructed solving several of the problems alluded to above. By constructing a remodulating interface comprising a power line data interface and a remodulator, the interface is capable of being tuned to the correct UHF channel through the power line data interface by a dual tuner STB containing a similar power line data interface. This allows the user to use a second TV to receive a second satellite channel without having to ever remember which UHF channel the second tuner provides. Some STBs may be configured to automatically select a vacant UHF channel and transmit the channel number (or its frequency) to the remodulating interface using power line data transfer. The remodulating interface then frequency shifts an input on the selected UHF channel to either TV channel 3 or TV channel 4. This keeps the UHF transfer of the satellite channel invisible to the consumer and allows them to operate both televisions in a similar fashion.

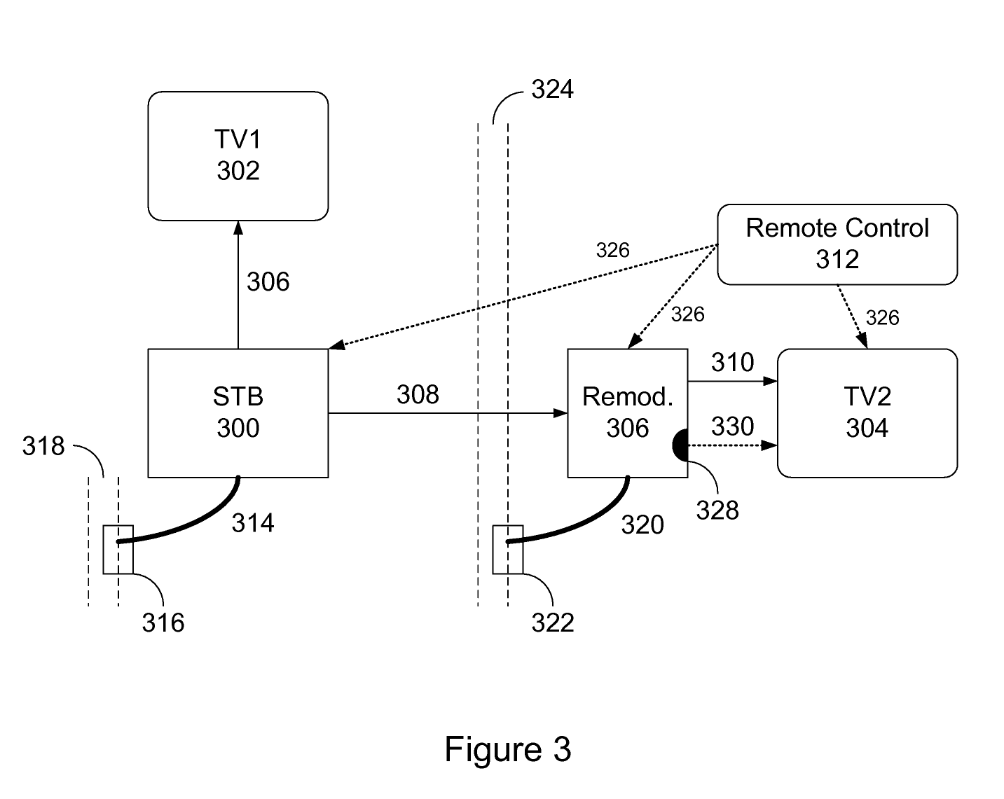

FIG. 3 illustrates an example two television system including a dual tuner STB, and a remodulating interface including a power line data interface according to an exemplary embodiment of the present invention. While this example shows two television sets, this embodiment of the present invention may be expanded to any number of remodulating interfaces and television sets all within the scope of the present invention. In this embodiment of the present invention a dual tuner STB 300 includes a HomePlug® interface and is configured to provide satellite video to a first television 302 and a second television 304. Those of skill in the art will recognize that while this example embodiment uses a HomePlug® interface, any other method for data transfer, such as RF or bi-directional protocol on coax, may be used within the scope of the present invention. The second television 304 may be in a different room from the STB 300 and there may be a wall 324 between the STB 300 and the second television 302. The first output 306 from the STB 300 is set to either channel 3 or 4, or to another convenient local TV interface such as RCA or S-video inputs, as described above. Other embodiments may use HDMI (High-Definition Multimedia Interface) or component video inputs, all within the scope of the present invention. The second output 308 from the STB 308 is set to one of the UHF channels. This UHF channel may be user selectable in an embodiment of the present invention, while other embodiments may include a STB 300 capable of automatically selecting a vacant UHF channel. Those of skill in the art will recognize that channels other than UHF channels (such as one of the VHF channels) may be used within the scope of the present invention.

The HomePlug® interface in the STB 300 is configured to send and/or receive control signals (such as frequency data) through the standard electrical wiring in the customer's home. The STB 300 receives electrical power and transmits and receives HomePlug® signals through a power cord 314 connected to a standard electrical socket 316 in a first wall 318 of the customer's home. Note that there is no requirement that the power cord 314 be directly plugged into an electrical socket 316 or that the socket be located in a wall 318 (extension cords and other compatible electrical wiring and devices may be used within the scope of the present invention). (Some devices such as surge suppressers, uninterruptible power supplies, and line conditioners may impede HomePlug® signals and may not be used between the power cord 314 and the electrical socket 316.)

The second output 308 from the STB is connected to a remodulating interface 306 using a coaxial cable which passes through a second wall 324. The remodulating interface 306 also includes a power line data interface configured to send and/or receive control signals through the standard electrical wiring in the customer's home. Those of skill in the art will recognize that while this example embodiment uses a HomePlug® interface, any other equivalent method for power line data transfer may be used within the scope of the present invention. The remodulating interface 306 receives electrical power and transmits and receives HomePlug® signals through a power cord 320 connected to a standard electrical socket 322 in a second wall 324 of the customer's home. Note that there is no requirement that the power cord 320 be directly plugged into an electrical socket 322 or that the socket be located in a wall 324.

Optionally, the customer may use one or more remote controls 312 to control one or more of the STB 300, the two TVs 302 and 304, and the remodulating interface 306. While remote controls located near the STB 300 and in the line of sight of the STB 300 may transmit IR signals 326, remote controls 312 located in other rooms will need to use other signals, such as UHF 326, to transmit control signals to the other devices. In some embodiments of the present invention, the remote control 312 may be configured to send a reset signal 326 to the STB 300 and the remodulating interface 306. In other embodiments the remote control 312 may transmit IR signals and the remodulator 306 may be used to forward the remote control signals to the set top box 300, eliminating the cost of the UHF technology, and simplifying the system design and customer experience. This reset signal 326 causes the STB 300 and the remodulating interface 306 to communicate through the HomePlug® interface and automatically configure the remodulating interface 306 to tune to the UHF channel that the STB 300 is using to direct the satellite video to the second output 308.

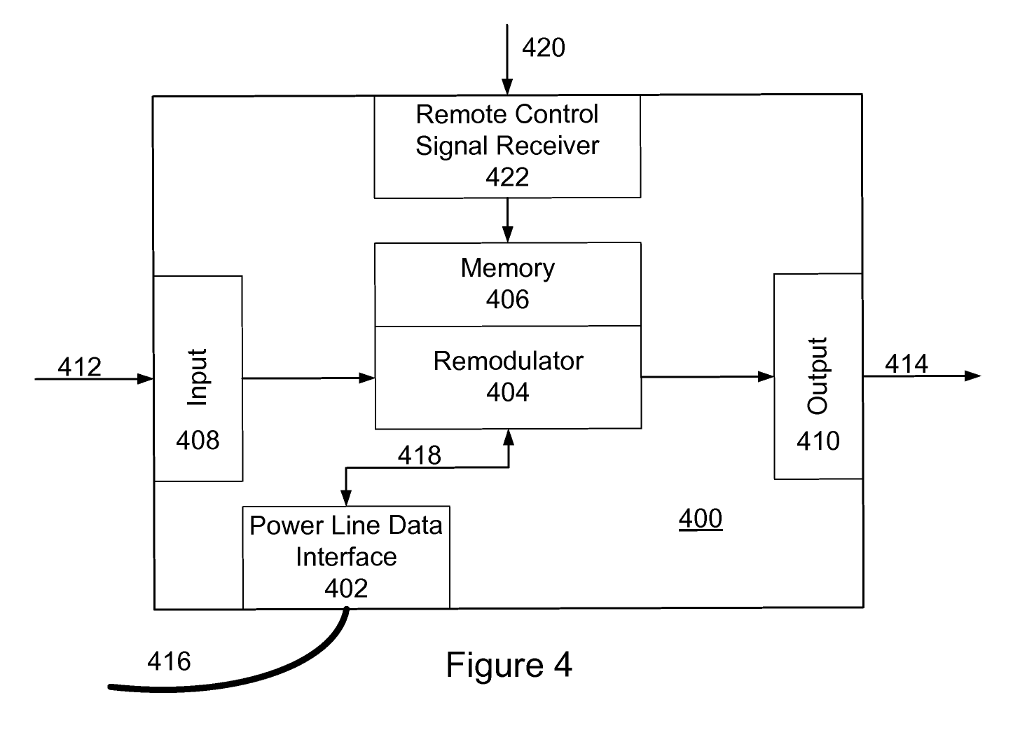

Optionally, the remodulating interface 306 (or the remote control 312 in other embodiments) could include an IR light source 328 and be positioned such that it is able to send IR commands 330 to the television. Upon receiving a reset signal the remodulating interface 306 would use the IR light source 328 to tune the customer's television to the proper channel (3 or 4) for reception of the satellite video coming from the remodulating interface 306. Still other embodiments of the present invention may be configured to allow the IR light source 328 to control (in modes other than the tuning mode previously discussed) the television remotely through the STB 300 within the scope of the present invention. The remodulating interface 306 is shown in greater detail in FIG. 4.

While the example system illustrated in FIG. 3 includes a single STB 300, other systems may contain multiple STBs each having multiple UHF channel outputs sharing the same in-home cable system. The remodulator 306 enables the TVs to easily switch between the multiple STBs and select individual UHF channel outputs from any of the STBs for display on TV2 304. Other systems may include STBs designed for receiving cable television or over-the-air television signals within the scope of the present invention.

FIG. 4 illustrates an example remodulating interface according to an exemplary embodiment of the present invention. This remodulating interface 400 includes a power line data interface 402, a remote control signal receiver 422, a remodulator 404, a memory 406, an input 408, and an output 410. Those of skill in the art will recognize that while this example embodiment uses a HomePlug® interface, any other method for power line data transfer may be used within the scope of the present invention. The HomePlug® interface 402 is configured to send and/or receive control signals 418 (such as frequency or channel data) through a power cord 416, which also may provide electrical power to the remodulating interface 400. These control signals 418 may include such data as the input frequency datum (or channel), the output frequency datum (or channel), remote control signals to the STB, and STB control signals to the TV. The HomePlug® interface is configured to store this data in the memory 406, and optionally pass the data through the remodulator 404 as shown in this example embodiment. A remote control signal receiver 422 is configured to receive control signals 420 from a remote control (not shown) and also store these control signals in memory 406, and optionally pass the control signals through the remodulator 404. Similar to the control signals 418 received through the power line data interface 402, the control signals 420 from a remote control may also include such data as the input frequency datum (or channel), the output frequency datum (or channel), remote control signals to the STB, and STB control signals to the TV. The input 408 is configured to receive satellite video signal 412 from a STB and pass the video data to the remodulator 404. The remodulator 404 frequency shifts the satellite video signal from a first frequency (corresponding to a first UHF channel) to a second frequency (corresponding to channel 3 or 4). The remodulator 404 also may convert the signal to a format compatible with a convenient TV output, such as RCA or S-video. These first and second frequency data (or their corresponding TV channels) may be stored in the memory 406 coupled to the remodulator 404. Once the remodulator 404 frequency shifts the satellite video data, it is made available at the output 410 of the remodulating interface device 400 where it may be sent to a TV through an output cable 414. Those of skill in the art will recognize that other applications of the present invention may use first frequencies other than those corresponding to a UHF TV channel and second frequencies other than those corresponding to TV channel 3 or 4, all within the scope of the present invention.

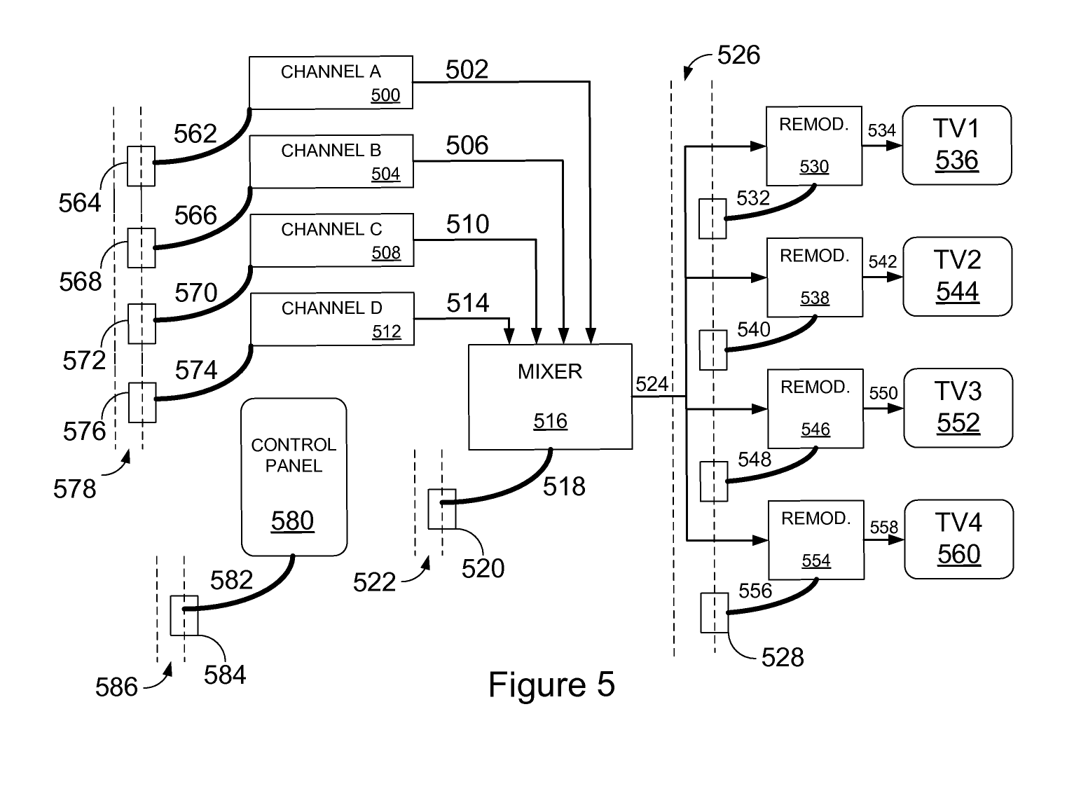

FIG. 5 illustrates an example application of a remodulating interface device according to an embodiment of the present invention. In some situations, such as an airport, restaurant, or bar, it is common to have a plurality of TVs set to a plurality of different satellite TV channels, or other sources such as cable TV, computer servers, or the like. In this example embodiment, a first satellite tuner 500 may provide Channel A 502 and includes a HomePlug® interface coupled to the electrical network through a power cable 562 coupled to a standard electrical outlet 564 in a wall 578. A second satellite tuner 504 may provide Channel B 506 and includes a HomePlug® interface coupled to the electrical network through a power cable 566 coupled to a standard electrical outlet 568 in a wall 578. A third satellite tuner 508 may provide Channel C 510 and includes a HomePlug® interface coupled to the electrical network through a power cable 570 coupled to a standard electrical outlet 572 in a wall 578. A fourth satellite tuner 512 may provide Channel D 514 and includes a HomePlug® interface coupled to the electrical network through a power cable 574 coupled to a standard electrical outlet 576 in a wall 578. The TV channel output signals provided by each satellite tuner may include any standard NTSC (National Television System Committee), PAL (Phase Alternating Line), ATSC (Advanced Television System Committee), or any other format of television signals. Some systems may use high definition (HD) digital signaling using 8VSB (8-level Vestigial Sideband Modulation), while others may use standard definition television signals, or a mixture of both. These satellite TV signals may be sent to a mixer 516 where the plurality of input channels 502, 506, 510, and 514 are converted to a plurality of UHF channels and mixed together into a single output 524. This mixer output 524 is comprised of the plurality of UHF channels and may be run to a plurality of TVs through standard coaxial cable. This cable may be run through walls 526 and into rooms some distance away from the mixer 516. The mixer 516 receives electrical power and transmits and receives HomePlug® signals through a power cord 518 connected to a standard electrical socket 520 in a first wall 522 of the customer's home. Note that there is no requirement that the power cord 518 be directly plugged into an electrical socket 520 or that the socket be located in a wall 522. Also, signals may be transferred through media other than HomePlug® signals, such as wireless, or other data transmission protocols.

A first remodulating interface device 530 is coupled to the mixer output 524, and sends a first TV signal 534 to a first TV 536. This first remodulating interface device 530 also includes a HomePlug® interface and is coupled to the electrical network through a power cable 532 coupled to a standard electrical outlet 528. A second remodulating interface device 538 is coupled to the mixer output 524, and sends a second TV signal 542 to a second TV 544. This second remodulating interface device 538 also includes a HomePlug® interface and is coupled to the electrical network through a power cable 540 coupled to a standard electrical outlet 528. A third remodulating interface device 546 is coupled to the mixer output 524, and sends a third TV signal 550 to a third TV 552. This third remodulating interface device 546 also includes a HomePlug® interface and is coupled to the electrical network through a power cable 548 coupled to a standard electrical outlet 528. A fourth remodulating interface device 554 is coupled to the mixer output 524, and sends a fourth TV signal 558 to a fourth TV 560. This fourth remodulating interface device 554 also includes a HomePlug® interface and is coupled to the electrical network through a power cable 556 coupled to a standard electrical outlet 528. Finally, a centralized control panel 580 is provided including a HomePlug® interface and is coupled to the electrical network through a power cable 582 coupled to a standard electrical outlet 584 in a wall 586. Using the HomePlug® interface, this control panel is used to monitor and control the tuners 500, 504, 508, and 512, the mixer 516 or the remodulators 530, 538, 546, and 554.

Those of skill in the art will recognize that while this example embodiment uses HomePlug® interfaces, any other method for power line data transfer may be used within the scope of the present invention. Those of skill in the art will also recognize that any number of tuners 500, 504, 508, and 512, and any number of TVs 536, 544, 552, and 560 may be used within the scope of the present invention. The TVs may be placed in different rooms or locations, and each remodulation interface may be independently tuned to any one of the UHF channels in the mixer output 524. Optionally, a customer may use one or more other remote controls 560, to control the tuners 500, 504, 508, and 512, the mixer 516 or the remodulators 530, 538, 546, and 554. This remote control 560, may use IR or UHF or other signals 562 to communicate with the tuners 500, 504, 508, and 512, the mixer 516 or the remodulators 530, 538, 546, and 554.

Some embodiments may use multiple mixers 516 and the remodulators would allow any of the TVs to receive any desired video output from any of the mixers within the system. In other words, the TVs are not locked to a single mixer, but may access signals from any mixer within the entire system.

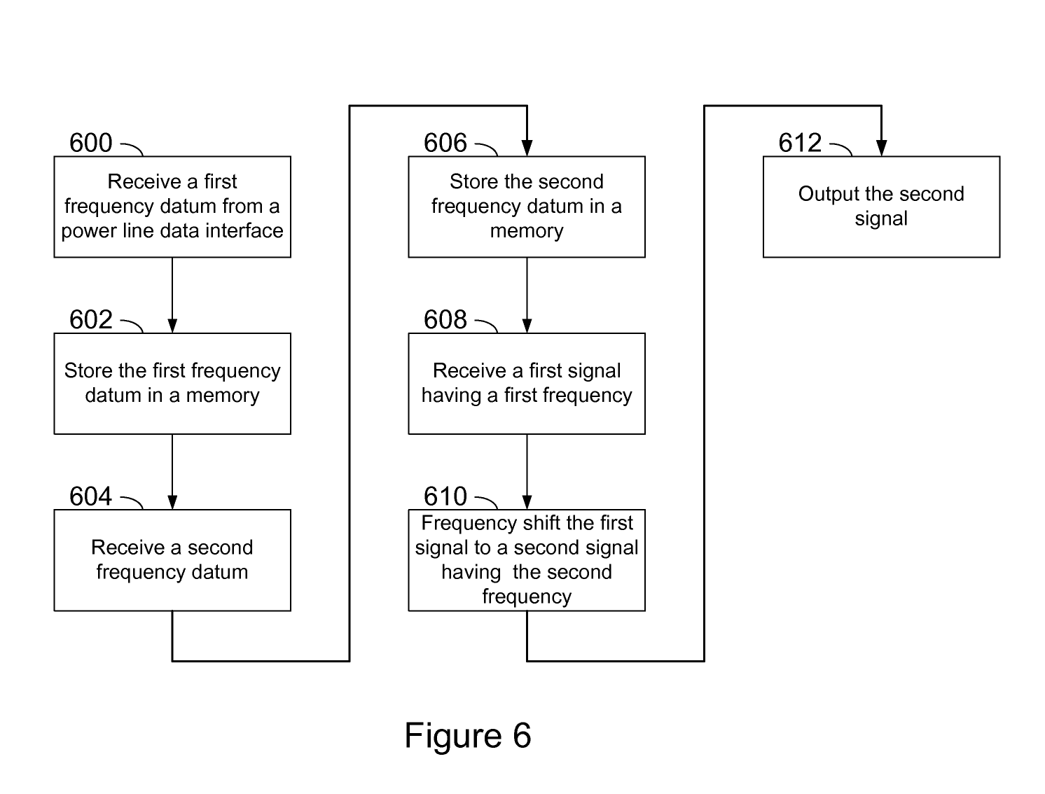

FIG. 6 illustrates a method for remodulating a TV signal according to an exemplary embodiment of the present invention. Referring to FIG. 6, in an operation 600 a first frequency datum is received from a power line data interface. In an operation 602 the first frequency datum is stored in a memory. In an operation 604 a second frequency datum is received, possibly from a HomePlug® interface. In an operation 606 the second frequency datum is stored in a memory. In an operation 608 a first signal having a first frequency is received. In an operation 610 the first signal having the first frequency is frequency shifted into a second signal having the second frequency. In an operation 612 the second signal having the second frequency is output. Those of skill in the art will recognize that not all of these exemplary operations are required within the scope of the present invention. Operations may be added or removed from this method and the operations may be performed in alternate sequences, all within the scope of the present invention.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A remodulating interface device comprising:
a memory configured to store a first frequency datum;
a power line data interface electrically coupled to the memory, and configured to receive the first frequency datum and store the first frequency datum in the memory;
an input configured to receive a first signal having a first frequency indicated by the first frequency datum;
an output configured to output a second signal having a second frequency; and
a remodulator electrically coupled to the memory, the input, and the output, and configured to frequency shift the first signal from the first frequency to the second signal at the second frequency.

2. The device of claim 1, wherein the memory is also configured to store a second frequency datum indicating the second frequency.

3. The device of claim 2, wherein the power line data interface is also configured to receive the second frequency datum and store the second frequency datum in the memory.

4. The device of claim 1, wherein the first frequency corresponds to a UHF TV channel.

5. The device of claim 1, wherein the second frequency corresponds to a TV channel selected from the group consisting of TV channel 3 and TV channel 4.

6. The device of claim 1, wherein the first signal is selected from the group consisting of: a satellite video signal, a cable television video signal, and an over-the air television video signal.

7. The device of claim 1, further comprising:
an infrared diode configured to send a control signal to a television.

8. The device of claim 1, wherein a physical configuration of the output is selected from the group consisting of: an RCA connector, a S-Video connector, a HDMI connector, or a component video connector.

9. A satellite television system comprising:
a set top box comprising:
a first power line data interface configured to transmit a first frequency datum; and
a remodulating interface device comprising:
a memory configured to store the first frequency datum;
a second power line data interface electrically coupled to the memory, and configured to receive the first frequency datum and store the first frequency datum in the memory;
an input configured to receive a first signal having a first frequency indicated by the first frequency datum;
an output configured to output a second signal having a second frequency; and
a remodulator electrically coupled to the memory, the input, and the output, and configured to frequency shift the first signal from the first frequency to the second signal at the second frequency.

10. The system of claim 9, wherein the memory is also configured to store a second frequency datum indicating the second frequency.

11. The system of claim 10, wherein the second power line data interface is also configured to receive the second frequency datum and store the second frequency datum in the memory.

12. The system of claim 9, wherein the first frequency corresponds to a UHF TV channel.

13. The system of claim 9, wherein the second frequency corresponds to a TV channel selected from the group consisting of TV channel 3 and TV channel 4.

14. The system of claim 9, wherein the first power line data interface is configured to transmit a first frequency datum in response to a reset signal.

15. The device of claim 9, wherein a physical configuration of the output is selected from the group consisting of: an RCA connector, a S-Video connector, a HDMI connector, or a component video connector.

16. A method for remodulating a TV signal comprising the steps of:
a) receiving a first frequency datum through a power line data interface;
b) storing the first frequency datum in a memory;
c) receiving a first signal having a first frequency indicated by the first frequency datum;
d) frequency shifting the first signal from the first frequency to a second signal having a second frequency; and
e) outputting the second signal.

17. The method of claim 16, further comprising the steps of:
f) receiving a second frequency datum indicating the second frequency; and
g) storing the second frequency datum in a memory.

18. The method of claim 17, wherein the second frequency datum is received through a power line data interface.

19. The method of claim 16, wherein the first frequency corresponds to a UHF TV channel.

20. The method of claim 16, wherein the second frequency corresponds to a TV channel selected from the group consisting of TV channel 3 and TV channel 4.

21. The method of claim 16, wherein the first signal is selected from the group consisting of: a satellite video signal, a cable television video signal, and an over-the air television video signal.

22. The method of claim 16, wherein the second signal is output using a physical configuration selected from the group consisting of: an RCA connector, a S-Video connector, a HDMI connector, or a component video connector.
